(19) United States
(12) Patent Application Publication
(10) Pub. No.: US 2024/0294396 A1
(43) Pub. Date: Sep. 5, 2024

(54) WATER TREATMENT SYSTEM

(71) Applicant: Bo Hachtel, Fort Atkinson, WI (US)

(72) Inventor: Bo Hachtel, Fort Atkinson, WI (US)

(21) Appl. No.: 18/117,113

(22) Filed: Mar. 3, 2023

(51) Int. Cl. C02F 1/00; B01D 39/20

(52) U.S. Cl. CPC C02F 1/001; B01D 39/2055; B01D 39/2068; B01D 2101/02; C02F 2001/007; C02F 2101/14; C02F 2101/322; C02F 2201/005; C02F 2209/003; C02F 2209/40

(57) ABSTRACT

An example water treatment system described herein includes a pre-filter system, an activated carbon filtration system including a filter media, a water sampling system having a water sample valve, a totalizing meter, and a piping system configured to couple the pre-filter system, the activated carbon filtration system, the water sampling system, and the totalizing meter in series. The activated carbon filtration system comprises a dual tank system having a first and second tank, each of the first and second tanks includes a filter media, the filter media being an activated carbon filter media. The water treatment system is configured such that water passing through the system maintains a minimum specified contact time with the activated carbon filter media.

### BACKGROUND

This disclosure relates to an apparatus and method for removing harmful organic chemicals and compounds from a water supply.

Volatile organic compounds (VOCs) are chemicals that both vaporize into air and dissolve in water. VOCs are pervasive in daily life, for example they're used in industry, agriculture, transportation, and day-to-day activities around the home. Once released into groundwater, many VOCs are persistent and can migrate to drinking-water supply wells. The presence of elevated VOC concentrations in drinking water is a factor for concern; for example, VOCs have the potential to become carcinogenic (the tendency for a chemical to create tumors in the body).

Two additional contaminants, sometimes referred as “forever chemicals,” have also emerged: perfluorooctanoic acid (PFOA) and perfluorooctane sulfonate (PFOS). Like VOCs, these are also human-made compounds that do not occur naturally in the environment but are persistent in drinking water supplies, typically associated with manufacturing locations, industrial use, or disposal. In some circumstances, certain PFAS (the class of chemicals that includes PFOA and PFOS) can accumulate and stay in the human body for long periods of time. There is also evidence that exposure to PFOA can lead to adverse health outcomes in humans.

VOCs and PFAS have been increasingly found ground water, surface water, and other drinking water supplies. While water treatment solutions exist to remove VOCs and PFAS, current devices are wasteful and expensive. In some applications, existing water treatment systems do not fully remove contaminants. For example, some systems may reduce VOCs, but may be incapable of reducing PFAS; other water treatment devices may only reduce PFAS. Existing systems claim to reduce contaminants, but do not however, provide a level to which reduction is achieved.

Another water treatment alternative is desired to address one or more of the above issues.

### SUMMARY

In one or more embodiments, this disclosure relates to a water treatment system having an activated carbon filtration system, particularly, a dual tank system. The dual tank system provides the means for a user to fully remove VOCs, PFAS, and other harmful contaminants from a water supply.

In one or more embodiments, this disclosure relates to a water treatment system having an activated carbon filtration system including a dual tank system, each tank of the dual tank system having activated carbon filter media. In one or more embodiments, this disclosure further relates to a water treatment system having a dual tank system, each tank of the dual tank system including a first filter media and a second filter media. In at least one example construction, each tank of the dual tank system includes coconut shell-based activated carbon filter media and gravel filter media. According to one or more constructions, an example water treatment system described herein is configured such that water passing through system remains in contact with the activated carbon for a specified time. In at least one construction, an example water treatment system includes a flow restrictor provided to achieve a desired flow rate such that water passing through the system remains in contact with the activated carbon for a specified time.

In another embodiment, an example water treatment system described herein includes a pre-filter system. In one construction, the pre-filter system is coupled in series and is provided between the water supply (e.g., an inlet or point of entry) and the dual tank system. That is, the inlet water passes through the pre-filter prior to entering the dual tank system. According to one or more embodiments, the pre-filter system can include a spin-down filter or a cartridge sediment filter.

In one or more embodiments, this disclosure further relates to a water treatment system having a water sampling system including one or more water sample valves. An example water treatment system can include three water sample valves. In one construction, a first water sample valve is provided coupled between the pre-filter and the first tank of the dual tank system; a second water sample valve is provided coupled between the first and second tanks of the dual tank system; and a third water sample valve is provided coupled in series following the second tank of the dual tank system.

In another embodiment, an example water treatment system described herein includes a totalizing meter. The totalizing meter is provided coupled in series prior to a point of exit of the system. In at least one construction, the totalizing meter is provided to monitor and measure the cumulative flow volume and flow rate of water passing through the water treatment system. In another example construction, the totalizing meter allows a user to optimize scheduled maintenance and prevent system failure.

In one or more or embodiments, the water treatment system described herein is easily installed, configurable to be used with various water supply inlets, and requires little maintenance and upkeep. The water treatment system is scalable to meet demand and can be used in a variety of different applications. Such applications may include, but are not limited to, residential, commercial, and industrial applications. An example water treatment system described herein can also be easily manufactured using relatively inexpensive materials. As mentioned above, the water treatment system can include coconut shell-based activated carbon filter media. Coconut shell-based carbon is environmentally friendly, readily available, and sustainable. Thus, the water treatment system may be available for a number of different uses and may be accessible by a larger portion of the population (compared to existing water treatment systems).

These and other features, advantages, and embodiments of apparatus and methods according to this invention are described in, or are apparent from, the following detailed descriptions of various examples of embodiments.

### BRIEF DESCRIPTION OF THE DRAWINGS

Various examples of embodiments of the systems, devices, and methods according to this invention will be described in detail, with reference to the following figures.

FIG. 1 depicts a perspective view of an example water treatment system.

FIG. 2 depicts a front view of the water treatment system of FIG. 1.

FIG. 3 depicts a top view and a partial cross-sectional view of the water treatment system of FIG. 1.

FIG. 4 shows a partial cross-sectional view depicting the inner workings of an example dual tank system for use with the water treatment system of FIG. 1.

FIG. 5 is a detailed cross-sectional view of the bottom region of an example dual tank system for use with the water treatment system of FIG. 1.

FIG. 6 depicts a front view of an example pre-filter system and an example water sample valve for use with the water treatment system of FIG. 1.

FIG. 7 depicts a front view of an alternative example pre-filter system and an example totalizing meter for use with the water treatment system of FIG. 1.

FIG. 8 is a flow chart depicting a method of installing the water treatment system.

FIG. 9 is a flow chart depicting a method of replacing a tank of the dual tank system for use with the water treatment system.

FIG. 10 depicts a top view of a portable implementation of an example water treatment system.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

Within the scope of this application, it is expressly intended that the various aspects, embodiments, examples, and alternatives set out in the preceding paragraphs, and the claims and/or the following description and drawings, and in particular the individual features thereof, may be taken independently or in any combination. That is, all embodiments and all features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### DETAILED DESCRIPTION OF THE DRAWINGS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with government-related (including foreign, domestic, and international), system-related, and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Often referred to as “forever chemicals,” volatile organic compounds (VOCs) and per-and polyfluoroalkyl substances (PFAS) are human-made compounds that do not occur naturally in the environment. VOCs and PFAS have been increasingly found ground water, surface water, well water, and other drinking water supplies due to environmental contamination typically associated with manufacturing locations, industrial use, improper disposal, or chemical spills/disasters. VOCs and PFAS can persist in the environment for decades without degrading or dissipating. Exposure to these compounds can lead to adverse health outcomes in humans, including cancer, thyroid disease, and reproductive issues.

Activated carbon filtration is the benchmark treatment method for effectively removing VOCs and PFAS from water supplies. Also known as charcoal, activated carbon can be made from relatively inexpensive material, such as for example, coconut shells. Activated carbon may also be made from coal, wood, or any other suitable base material. Pores in the activated carbon filter media attract and trap VOCs and PFAS, effectively removing them from the water. More specifically, removal of VOCs and PFAS from water can be achieved by ensuring sufficient contact with the activated carbon for a specified time.

Referring to the Figures, a water treatment system 100 is disclosed. The water treatment system 100, collectively “the filtration system,” “the treatment system,” or “the system,” provides a means for fully removing VOCs and PFAS from a water supply, i.e., such matter serves to remove harmful chemicals, contaminants, and organic compounds. The system 100 described herein also provides means to ensure treated water is safe, clean, and deficient of foreign and foul odor or taste. Thus, the system 100 may protect a user from potential exposure due to ingestion, inhalation (e.g., breathing compounds which may become aerosolized when cooking or bathing) or absorption (e.g., through the skin). The example filtration system 100 does not include or require electricity, nor does the system regenerate/backwash, thus saving electricity, water, and use/abuse of a septic system. While specific examples are described and illustrated, it should be understood, of course, that the invention is not necessarily limited to the particular embodiments or constructions illustrated herein.

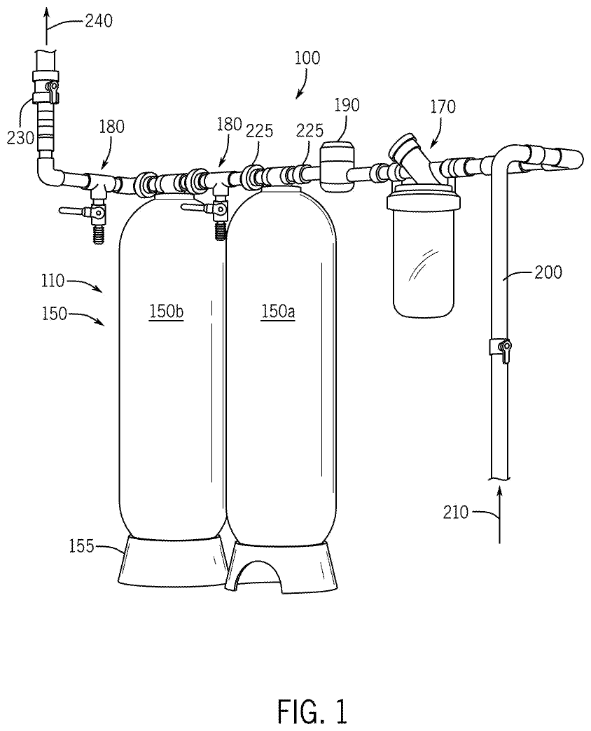

FIG. 1 is a perspective view of an example water filtration system 100. According to one or more examples, the system 100 includes an activated carbon filtration system 110 having a filter media 120. The activated carbon filtration system 110 may include one or more filter medias 120. In one example, the filter media 120 can comprise an activated carbon filter media 130 and a gravel filter media 140. In one or more constructions, the activated carbon filtration system 110 comprises a dual tank system 150 having first tank 150a and a second tank 150b. Each of the first and second tanks, alternatively referred to herein as “filter tanks,” 150a, 150b are provided with filter media 120. In the implementation shown, the first and second tanks 150a, 150b are provided adjacent to one another and are coupled in series such that water entering the system 100 flows sequentially from the first tank to the second tank. According to one example, the system 100 may include a flow restrictor 160 configured to restrict a flow of water (i.e., a flow rate) through the system. Thus, the example filtration system 100 can be configured to ensure that water passing through the system maintains a minimum specified contact time with the filter media 120, particularly the activated carbon filter media 130, before being expelled from the system. The filtration system 100 additionally includes a pre-filter system 170 configured to prevent sediment, suspended particles, and other contaminants (e.g., excess iron and manganese) from entering the system. The pre-filter system 170 may be disposed such that water entering the system passes through the pre-filter prior to passing through the dual tank system 150. Water treatment system 100 can include a water sampling system 180 having one or more water sample valves. In a non-limiting example, a first water sample valve 181 may be provided coupled between the pre-filter 170 and the first tank 150a of the dual tank system 150; a second water sample valve 182 may be provided coupled between the first and second tanks 150a, 150b of the dual tank system; and a third water sample valve 183 may be provided coupled in series following the second tank 150b of the dual tank system. Thus, the sampling system 180 allow a user to draw a water sample across various regions of the system 100. In yet another example, the filtration system 100 can include a totalizing meter 190 configured to monitor and measure the cumulative flow volume and flow rate of water passing through the water treatment system. Piping 200 is used to install the filtration system 100 to an existing water supply. The piping is additionally provided to couple the individual components of the system.

In every application, an accurate measurement of the water system demand (e.g., in gallons per minute) must be made to determine the most optimal size filtration system needed. The filtration system 100 may have a maximum operating pressure of 80 pounds per square inch (PSI). In implementations where water supply pressure exceeds 80 PSI, a pressure reducing valve is included with the system 100. While the example water treatment system 100 is shown in a residential implementation, the system may be installed for use in a variety of applications. Such applications may include, but are not limited to, residential and/or communal living space installation, for example, in single-family homes, condominiums, apartments/apartment complexes, and other living spaces. The example system 100 can additionally be implemented in commercial, industrial, and other public works settings, such as for example, in schools, hospitals, hotels, restaurants, businesses, office spaces, and other suitable settings. The water treatment system 100 is scalable and may, in some circumstances, be suitable for larger applications. For example, the system 100 may be implemented, either alone or in conjunction with alternative water treatment solutions, for use within manufacturing plants/factories, distribution centers, and warehousing facilities. The system 100 can additionally be implemented as a part of a water treatment facility, such as, to serve a community (i.e., a town or city). According to another application, the system 100 can be implemented for operation in a mobile or portable setting, such as in recreational vehicles (RV), campers or camper trailers, motorhomes, ships or boats, etc. In one such construction, the system can be configured to couple to an existing water supply, such as a residential/municipal well or a municipal hydrant.

The example water treatment system includes a redundancy of activated carbon, thus ensuring the full removal of harmful contaminants which are traceable in a water supply. Activated carbon is extremely porous with a very large surface area, which makes it an effective adsorbent material. An approximate ratio of surface area may be one square meter per gram. The intermolecular attractions in the smallest pores result in adsorption. The pore size or pore diameter can include the following pore size groupings: macropores, above fifty (>50) nanometers (nm) in diameter; mesopores, two to fifty (2-50 nanometers in diameter; and micropores, under two nanometers in diameter. As discussed above, each tank of the dual tank system 150 comprises one or more filter medias 120. Filter medias 120 can be pelletized (pellets), powdered (powder), or granular (grains); alternative forms of media are possible. In one example, the filter media 120 can comprise an activated carbon filter media 130 and a gravel-based filter media 140. The activated carbon filter media can include, for example, granulated activated carbon, pelletized activated carbon, powdered activated carbon, impregnated activated carbon, and catalytic activated carbon. Impregnated activated carbon can be infused with inorganic impregnates, such as silver, iodine, or potassium permanganate. Catalytic activated carbon, sometimes referred to as surface-modified activated carbon, may initiate and enhance the chemical absorption process. In a preferred construction, the carbon filter media 130 is a coconut shell-based activated carbon filter media. Alternative activated carbon filter media may be used, such as, coal-based or wood-based activated carbon filter media. Activated carbon media having a low-dust composition is preferred. The gravel-based filter media 140 is provided to fill the lower region of the contact vessel and aid in distributing water throughout the activated carbon bed. Suitable medias can include, but are not limited to, anthracite filter media, gravel filter media, and silica sand media. Particle size, or a diameter, of the filter medias 130, 140 may range from roughly two-tenths of a millimeter (˜0.20 mm) to over six millimeters (>6 mm), however other sizes are possible.

The amount of activated carbon media needed may vary based on the application. To ensure full removal of VOCs and PFAS, water passing through the system must remain in contact with the activated carbon media bed for a minimum specified contact time. The specified contact time, also known as, Empty Bed Contact Time (EBCT) is a measure of the time during which a water to be treated is in contact with the treatment medium in a contact vessel, assuming that all liquid passes through the vessel at the same velocity. The following equations may be used to determine the volume of activated carbon needed. A conversion factor of 7.48 gallons per cubic foot is included in the formula.

$$EBCT ( min ) = \frac{Bed Volume ( {ft}^{3} ) \times 7.48 ( \frac{gal}{{ft}^{3}} )}{Flow Rate ( gpm )} \qquad [ Equation 1 ]$$

$$Bed Volume ( {ft}^{3} ) = Tank Area ( {ft}^{2} ) \times Depth ( ft ) \qquad [ Equation 2 ]$$

$$Bed Volume ( {ft}^{3} ) = \frac{Recommended Contact Time ( min ) \times Flow Rate ( gpm )}{7.48 ( \frac{gal}{{ft}^{3}} )} \qquad [ Equation 3 ]$$

To remove VOCs, it is recommended that water passing through the system must remain in contact with the activated carbon for at least seven (7) minutes. To remove PFAS, water passing through the system should remain in contact with the activated carbon for at least ten (10) minutes. Thus, in one or more implementations, the water treatment system 100 may be configured to achieve a specified contact time of at least seven minutes. In an example system selected to remove PFAS, the system can be configured to achieve a specified contact time of at least ten minutes. The recommended and/or specified contact time is based off a surrogate influent challenge. To qualify for the reduction of VOCs, an example device must reduce the influent challenge concentration of chloroform (a more difficult chemical to remove) at three hundred (300) parts per billion (ppb) with a ten percent (10%) variance at each sample point by a minimum of ninety five percent (95%). To qualify for the reduction of PFAS, an example device must reduce the influent challenge concentrations such that all effluent concentrations are less than 0.07 ppb.

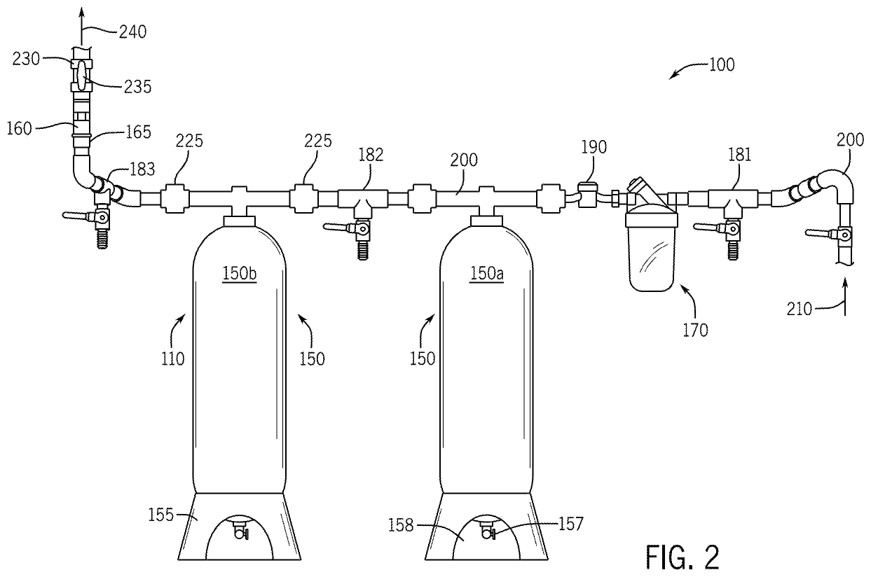

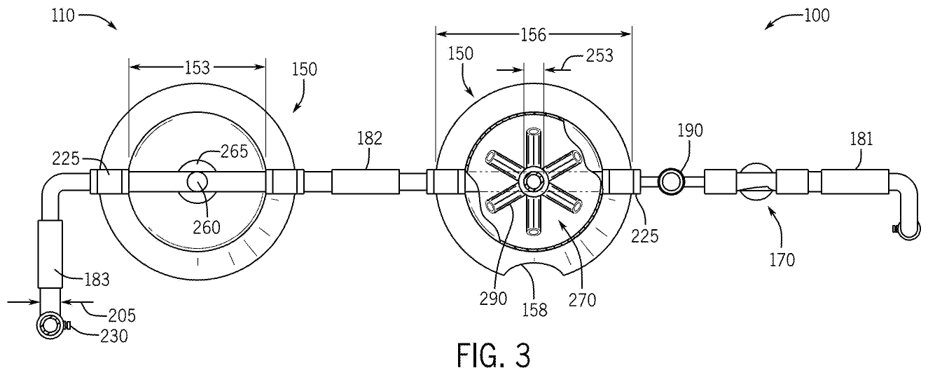

Turning to FIGS. 2-7, the individual components of an example water treatment system 100 will be described in more detail. With reference to FIG. 2, the filtration system 100 is shown installed or plumbed directly to a point of entry 210 of a water supply. A path of the flow of water 215 can be seen traveling sequentially through the system 100 (visually from right to left). In the example construction, the filtration system 100 is plumbed in a substantially straight line. That is, from a top view, the system 100 and its individual components may be collectively oriented in a substantially straight line (as shown in FIG. 3). However, the system 100 described herein can be plumbed in a variety of configurations, for example, to fit in a confined space or to avoid existing fixtures. In some applications, the water treatment system 100 may include bends, turns, or changes in elevation and direction. Thus, when viewed from above, a footprint of the water treatment system may vary in shape.

System 100 is coupled to the water supply point of entry (POE) 210 using a conventional piping system 200. In the implementation shown, piping 200 is made of polyvinyl chloride, or PVC. For residential implementations, example pipe (pipeline, waterline, channel, tube, hose, etc.) may be one inch (1″) in diameter. Other diameters are possible including, for example, one-half inch (½″), three-quarter inch (¾″), one and one-quarter inch (1 ¼″), one and one-half inch (1 ½″), etc. As mentioned above, the water treatment system 100 described herein is scalable/configurable for a variety of settings. Thus, it should be understood that a diameter of the piping used in the piping system 200 may vary and may, in some applications, be based on plumbing and/or building codes and requirements. In a preferred construction, example pipes are rigid (i.e., structurally self-supporting, or capable of supporting a load). Pipes may instead be malleable and/or flexible (e.g., in applications using hosing as opposed to rigid piping). In some examples, piping system 200 can include threading (e.g., at union points) configured to couple or secure the pipe to various components of the system 100. However, in the example construction, piping 200 is coupled to components of the system 100 by way of press fit. While PVC piping is shown and described, other suitable piping materials can be used including, for example, cross-linked polyethylene (PEX), acrylonitrile butadiene styrene (ABS), rigid copper, and galvanized steel.

Fittings 220 (e.g., union, connector, coupling, tee joints, elbow joints, etc.) are provided to install the system (e.g., at a point of entry or exit) and to couple the individual components of the filtration system. Example fittings are preferably certified by the National Sanitation Foundation (NSF) and can include unions 225 and shut-off valves 230, however, other fittings may be used. In a non-limiting example, the fittings 220 may include threads (threading) provided to couple adjacent components of the system 100. In another example, the fittings 220 can couple adjacent pipes or components of the system by way of a friction fit or press fit. In one such example, fittings 220 can additionally include an adhesive or bonding material, which may be applied to the components prior to being pressed together. As is known in the art, example fittings (unions 225 and shut-off valves 230) can be manufactured from a range of materials including but not limited to, for example, stainless steel, copper, brass, bronze, aluminum, nickel, and alloys thereof. The fittings may alternatively be formed of plastic, such as PVC, PEX, or ABS. In some applications, the fittings can additionally be made from rubber; other suitable materials are possible.

In more detail, the filtration system 100 includes one or more unions 225 provided to couple the components of the system. More specifically, unions 225 are provided on both inlets 151 and the outlets 152 of filter tanks 150a, 150b of the dual tank system. Unions 225 are additionally provided to couple tanks 150a, 150b, to water sample valves 181-183. According to one or more examples, unions 225 can additionally or alternatively couple tanks 150a, 150b to, for example, a flow restrictor 160, a pre-filter system 170, or a totalizing meter 190. Additionally, unions 225 may be provided to couple any combination of the aforementioned components, such as a connection between a pre-filter system 170 and a totalizing meter 190.

In the example construction, the water treatment system 100 further includes a shut-off valve 230, such as a ball valve, configured to couple the system to the water supply POE 210. According to one construction, the shut-off valve or control valve 230 allows a user to control a flow rate of the water passing through the system 100. The shut-off valve 230 can include a handle or lever 235 to control function of the valve. In an operating position (i.e., in a normal, open, or “ON” position), the shut-off valve 230 allows water to freely flow into the system 100. Valve 230 can additionally be moved to closed and intermediary positions to stop or limit the flow of water 215 entering the system, for example, to allow a user to complete system maintenance. In another application, the shut-off valve may alternatively be a rotary shut-off valve having a control knob (e.g., dial, wheel, crank, etc.). In such an example, the shut-off valve 230 can be operated by rotating the control knob clockwise to tighten (close) the valve, and counter-clockwise to loosen (open) the valve. Alternative multi-turn shut-off valves may be used in conjunction with the disclosed water treatment system 100.

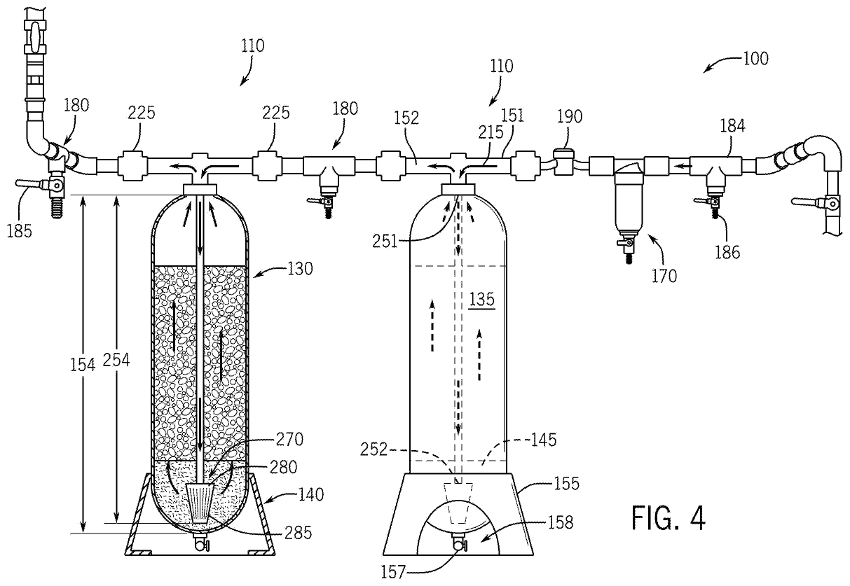

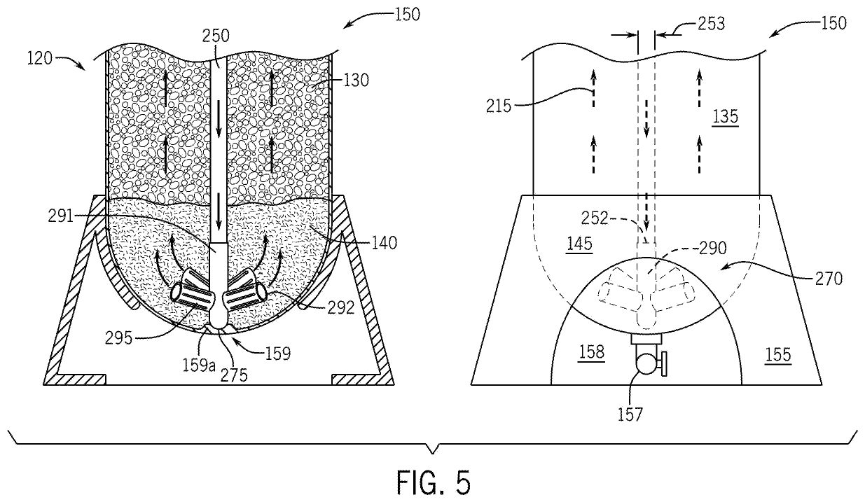

Example filter tanks of the activated carbon filtration system 110 are shown in more detail in FIGS. 4 and 5. According to one or more constructions, the activated carbon filtration system 110 comprises a dual tank system 150 including a first filter tank 150a and a second filter tank 150b. An example filter tank (vessel, chamber, etc.) described herein is preferably substantially cylindrical in shape, including a rounded top end (upper region) and bottom end (lower region). In other words, tanks are cylindrical with hemispherical ends. The shape may be alternatively referred to as a capsule shape. Other filter tank shapes and configurations are possible, such as for example, cube, cuboid/rectangular prism, triangular, spherical, ellipsoidal, upside-down pyramidal, upside-down conical, and combinations thereof. A diameter 153 of filter tanks 150a, 150b can vary depending on the application. In a residential implementation, the diameter of each tank may range from eight inches (8″) to twenty plus inches (20+″). However, a larger diameter tank can be used for water treatment systems installed in high-demand settings. For example, the diameter 153 of filter tanks 150a, 150b may be sixty inches (60″) or greater. Similarly, a height 154 of filter tanks 150a, 150b can vary depending on the application, tank heights can range from thirty-five inches (35″) to sixty-five plus inches (65+″). For non-residential applications, filter tank height 154 may be eighty inches (80″) or greater. Smaller treatment systems 100, such as for a single-family home, may implement filter tanks 150a, 150b ranging from a minimum volume of roughly ten gallons (˜10 gal) to a maximum volume of roughly 90 gallons (˜90 gal). For larger applications, tanks 150a, 150b can have volumes in excess of six hundred and fifty gallons (650+gal). Thus, an example filtration tank according to this disclosure can vary in total volume. Each tank of the dual tank system 150 may be preferably formed of fiberglass. In more detail, tanks 150a, 150b may include a polyethylene liner material wound with continuous fiberglass and sealed with epoxy resin. In other examples, tanks 150a, 150b can be formed of other materials, such as, plastic, rubber, stainless steel, or other suitable materials.

Each tank of the dual tank system 150 may be provided on a base. In the construction shown, base 155 is formed of reinforced plastic; however, alternative materials may be used to construct the base. According to one or more examples, tanks 150a, 150b may be coupled to the base 155 in a variety of ways. In one construction, each of tanks 150a, 150b can include a projection (not shown), such as a lip, notch, edge, etc., configured to engage with a corresponding lip provided on the base. In the example implementation in FIG. 5, the base includes a depression (e.g., a concave cutout/indentation) shaped to match a shape of the bottom of tanks 150a, 150b. In another non-limiting example, a diameter of the base 156 may be smaller than a diameter 153 of tanks 150a, 150b. In such a construction, filter tanks 150a, 150b may simply rest on top of the base 155, for example, as shown in FIG. 1. In one or more applications, filter tanks 150a, 150b can include a drain port 157 (e.g., drain valve, drain aperture/hole/orifice, etc.) at the bottom end of the tank. In at least one such construction, a portion of the base 158 may allow for access to the drain port 157. A portion of the drain port can be threaded, for example, to facilitate connection to a hose or shut-off valve.

First and second tanks 150a, 150b are duplicates or twins of one another. In other words, the activated carbon filtration system 110 described herein includes a first tank and a second identical, redundant tank, alternatively referred to as lead-lag, worker-polisher, or worker-guard systems. Although a dual tank system is shown and described, more than two tanks may be installed in series. For example, three or more tanks may be coupled together, as opposed to using larger tanks, to achieve a greater flow rate of water passing through the system while maintaining a minimum specified contact time with the activated carbon filter media. The redundancy of the activated carbon filtration system 110 provides the means to completely remove contaminants, thus achieving a 100% safety factor. In the example construction shown, the first and second tanks 150a, 150b are provided adjacent to one another and are coupled in series such that water entering the system 100 flows sequentially from the first tank to the second tank. Piping 200 and unions 225 are provided to couple the first and second tanks 150a, 150b, and a water sample valve 182 is additionally provided between the first and second tanks.

As can be seen from the figures, a shape of an inner volume of the tanks 150a, 150b may match an overall shape of the tanks (e.g., predominantly capsule shaped). In some applications, the shape of the inner volume can include additional features. For example, in one construction, filter tanks 150a, 150b, can additionally include a distribution tube seat feature 159 provided at the lower-most point within the filter tanks 150a, 150b. In more detail, the seat feature 159 can comprise an indentation 159a (e.g., notch, ridge, step, aperture, lip, catch, etc.) integral with the inner surface of the tank and disposed in a central region on the bottom of the tank. The distribution seat feature 159 is configured to engage with a distribution tube, allowing a user to easily complete installation of the filter tanks 150a, 150b. In some examples, the distribution tube can be configured to snap into place, thus providing confidence that a user has correctly installed the distribution tube. Although the distribution tube seat feature 159 is shown as being integral with the tank's inner surface, the seat feature may alternatively be manufactured as a separate piece for installation.

Referring to FIG. 4, each of the first and second tanks 150a, 150b comprises a distribution tube 250 provided in a central aperture 260 at the top end of the tank. The example distribution tube 250 is coupled to a head 265 provided in the aperture and extends downward into the tank towards a bottom end of tank. The filter tank heads 265 simultaneously allow incoming water to flow down the distribution tube 250 and outgoing water to flow up and out of filter tanks 150a, 150b. In the example construction shown, each of the apertures includes threading (not shown) such that tank heads may couple to the tanks 150a, 150b by way of thread fit (i.e., heads can be screwed and tightened into position). Aperture 260 can additionally include an O-ring to advantageously seal the connection between the head and filter tanks 150a, 150b. In some constructions, a diameter 253 of the distribution tube may match a diameter of the piping 200 used to plumb the system 100; however, differing diameters are possible. In the construction shown, the distribution tube 250 extends down a center or central region of each of tanks 150a, 150b such that a bottom of the distribution tube abuts or sits proximate to the distribution tube seat feature 159 at the bottom end of the tank. Thus, in one or more examples, a total length 254 of the distribution tube may similarly match a height of the filter tank. The distribution tube can be formed stainless steel or copper; however, the distribution tube is preferably formed of plastic, such as PVC, PEX, and ABS.

A first (top/upper) end 251 of the distribution tube is coupled to the inlet 151 on the head 265 of the filter tank such that water flowing into the tank travels down the distribution tube before being expelled out of the tube and into the bottom of the tank. A second (bottom/lower) end 252 of the distribution tube can include a distribution apparatus 270. In at least one construction, the distribution apparatus, or a portion thereof, is configured to engage with the distribution tube seat. More specifically, a bottom surface of the distribution apparatus 270 is shaped to engage or sit within the distribution tube seat feature 159 provided in the inner-bottom surface of the filter tank. In a non-limiting example, the distribution apparatus 270 can include a projection 275 (e.g., an extension, notch, ridge, lip, edge, etc.) configured to engage with the indentation 159a of the distribution tube seat. In one or more examples, the distribution apparatus includes a distributor basket 280. In the example shown in FIG. 4, the distributor basket comprises slots 285 (apertures, holes, slits, screen, openings, etc.) to prevent filter media 120 from entering the distribution tube 250 and to allow water to evenly distribute into the filter tanks 150a, 150b. The distributor basket can have varying shapes including, but not limited to, cylindrical, cylindrical with a conical bottom, conical, conical with a flat bottom, cylindrical with a pyramidal bottom, cylindrical with a spherical bottom, or variations thereof. An example distributor basket 280 can be integrally formed with the distribution tube 250. In other constructions, the basket may be constructed as a separate piece configured to be coupled to the distribution tube, for example, by way of thread fit, press fit, or friction fit. A second example distribution apparatus 270 is shown in FIG. 5. In the example, the apparatus comprises a hub and lateral system 290. More specifically, the hub 291 can include a plurality of laterals 292 (projections, extensions, shoots, spokes, etc.) provided to evenly distribute water traveling down the distribution tube. Laterals are provided in a uniform pattern surrounding the hub and may, in some cases, be biased at an upward angle. Like the distributor basket, laterals may be constructed in a variety of shapes, such as for example, cylindrical, cylindrical with a conical bottom, conical, conical with a flat bottom, cylindrical with a pyramidal bottom, cylindrical with a spherical bottom, or variations thereof. In the example implementations shown in FIGS. 3 and 5, the hub 291 includes six and four cylindrically shaped laterals, respectively. However, other combinations are possible, for example, two, three, five, eight, or more laterals may be used. Like the distributor basket, each lateral 292 can include apertures 295, such as, slots, slits, mesh screens, holes, or a combination thereof to facilitate even distribution of water into the filter tanks 150a, 150b. Apertures 295 can vary in shape, possible shapes can include, for example, circle, oval, square, rectangle, hexagon, etc.

Referring again to FIG. 4, each of the filter medias 130, 140 may occupy selected regions or layers within the filter tanks 150a, 150b. In more detail, a first (lower/bottom) region 145 near the bottom portion of the tank includes gravel filter media 140 provided to evenly distribute water flowing from the distribution apparatus 270. The bottom portion of the tank is less optimal for filtration purposes; therefore, it is advantageous to use this portion of the tank to evenly distribute the water before passing through the activated carbon media bed 130. As can be seen in FIG. 5, the first region 145 is sufficiently deep such that gravel filter media 140 is provided completely surrounding and enveloping (i.e., burying) the distributor apparatus. In the example shown, gravel filter media 140 functions to fill the space near the bottom portion of the tank and is provided adjacent the distribution apparatus to aid in evenly distributing water. A top surface of the first region is preferably level or flat.

A second (upper/top) region 135 comprising the central and upper portions of the tank includes activated carbon filter media 130. As can be seen in FIGS. 4 and 5, water flows upwards through the activated carbon media bed. A flow rate of the water is controlled to achieve a desired contact time with the bed prior to being expelled at a top of the filter tanks 150a, 150b. The amount of activated carbon filter media needed can vary depending on the demand of the system. However, it remains consistent that each tank 150a, 150b of an example water treatment system 100 includes a specified redundancy of activated carbon, thus ensuring the full removal of harmful contaminants which are traceable in the water supply. In the example implementation, the second region includes an activated carbon media bed 130 comprising coconut shell-based activated carbon filter media. The upper-most portion of the second region 135 is preferably left open to allow outgoing water to settle prior to passing to the next component of the filtration system 100. In the example shown, a top surface of the filter media bed is displaced roughly six to eight inches (6″-8″) from a top of filter tanks 150a, 150b. Sufficient displacement between the top surface and the top of the tank is necessary to prevent filter media from migrating within the system 100.

The water treatment system 100 can be configured to control a flow rate of the water 215 passing through the carbon media bed such that the water remains in contact with the activated carbon for a specified time. An example system can have a flow rate ranging from three (3) to twenty (20) gallons per minute (gpm) depending on the configuration and the inlet water supply. It should be understood, of course, that alternative flow rates are possible, as is contemplated within Equations 1-3. In some applications, the flow rate of water may need to be reduced to achieve the desired contact time. In at least one construction, an example water treatment system includes a flow restrictor or limiter 160 provided to achieve a desired flow rate and thus the desired contact time. The flow restrictor is preferably coupled in series (i.e., in-line) within the system 100 in a region prior to the outlet 240 of the system 100. That is to say, the restrictor may be the final component coupled in series within the system. However, the restrictor 160 may instead be provided along a different region of the system, such as, at the water supply POE 210 or at the outlet of the second tank 150b. Flow restrictor 160 includes a control mechanism 165 and an orifice or aperture (not shown) which can be opened or closed to adjust a flow rate of water passing through the system 100. Different control mechanisms are possible including levers/handles, knobs, dials, keys, or set screws. In some examples, the flow restrictor 160 may be pre-configured to control a pre-determined flow rate of water. It should be understood, of course, that the use or necessity of a flow restrictor can depend on the application. Throughout the installation process of the filtration system 100, it may be necessary to repeatedly test the water to achieve the desired flow rate and specified contact time with the carbon media bed.

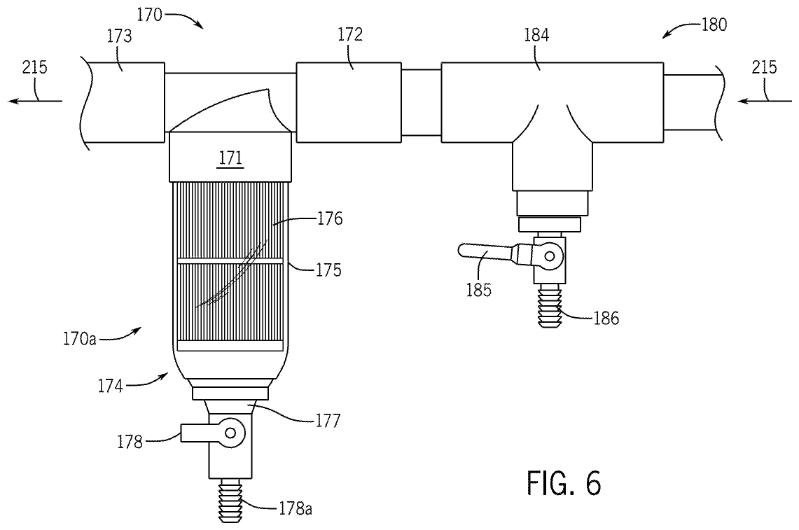

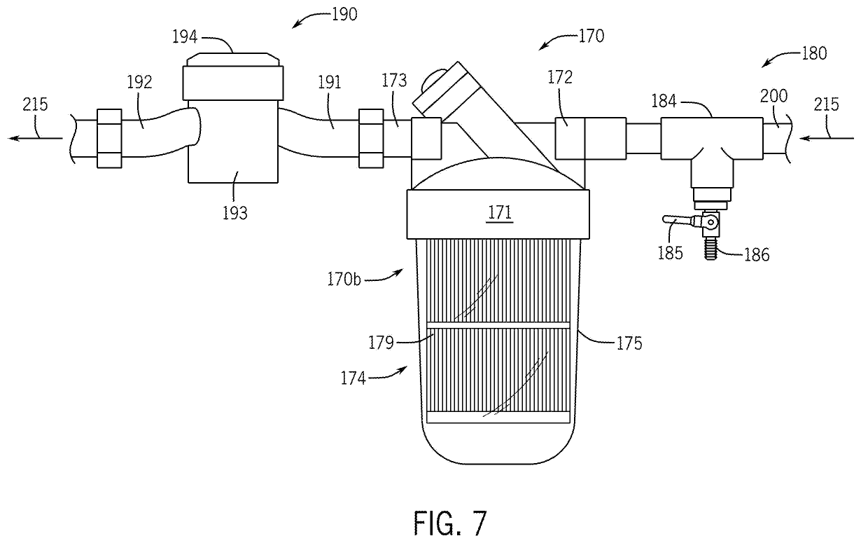

Turning to FIGS. 6 and 7, the water treatment system described herein includes a pre-filter system 170 configured to prevent sediment and other contaminants from being introduced to, or from migrating within, the filtration system 100. In the construction shown, the pre-filter is coupled in series and is provided between the water supply POE 210 and the dual tank system 150. In other words, the inlet water passes through the pre-filter 170 prior to entering the dual tank system. It should be appreciated that this aspect is consistent in every configuration of the water treatment system 100. In another non-limiting example, the pre-filter can instead be a post-filter configured to be installed prior to a point of exit 240 of the system, therefore preventing migration of sediments and other contaminants from entering subsequent water lines. More than one pre-filter system can be included in the system 100. For example, a first pre-filter may be installed to the water supply POE, and a second pre-filter (i.e., a post-filter) may be installed prior to a point of exit of the system.

In one example, the pre-filter system 170 comprises a spin-down sediment filter 170a. The spin down filter functions to filter/remove dirt, debris, sand, grit, and other contaminants from the water, therefore preventing contaminants from migrating into the activated carbon treatment system 110. More specifically, the design of the head advantageously diverts water into the chamber in a fashion that circulates the water around the filter housing causing dirt and debris to be pushed to the outside, which eventually settles in a trap positioned at the bottom of the chamber. An example spin-down filter can include a head or connection portion 171 having an inlet 172 and an outlet 173, and a filtration portion 174. In the figure, the head is formed of brass; however, other materials can be used (e.g., stainless steel, copper, bronze, aluminum, nickel, and alloys thereof). Each of the inlet 172 and outlet 173 can include threads for coupling to pipes 200 or additional components of the filtration system 100. Alternatively, inlet and outlet may be connected by way of press fit or friction fit. The filtration portion 174 comprises a filter cannister 175 (chamber, compartment, housing, container, etc.) having a mesh filter screen 176 disposed therein and a sediment trap 177 disposed at the lower-most point of the cannister. In the example shown, the cannister 175 is preferably formed of plastic and may, in some applications, be transparent to allow a user to quickly and easily determine when purging is needed. For example, the cannister, head and/or various components may be made of any polymeric (e.g., polyethylene, polypropylene, a polypropylene containing material, etc.) or composite (e.g., glass-reinforced polymer) material. The cannister is coupled to the head 171 using threads which allows a user to easily access the mesh filter screen for easy cleaning or replacement. The connection can additionally include an O-ring. An example filter screen can include varying mesh sizes ranging from size twenty (20) to size one thousand (1000), meaning the filter screen can have a micron rating ranging from roughly fifteen (˜15) microns to over one thousand (1000+) microns. It should be understood, however, that the aforementioned range is exemplary and non-limiting. In any application, water quality should be assessed before choosing the most optimal mesh screen size. Mesh screen 176 can be formed of either polyester or stainless steel. In some examples, more than one mesh screen can be used, such as a double-wall mesh screen (not shown). A manually operated flush valve 178 (e.g., a ball valve) is positioned at the bottom of the filter cannister and coupled to the trap 177. The example flush valve includes a handle or lever to operate the valve. Over the course of operation, the flush valve can be used to purge sediment caught in the trap. In a separate example not shown, the spin down filter can include an automatic flush valve configured to automatically flush or purge the sediment trap.

The pre-filter system 170 can additionally or alternatively comprise a cartridge sediment filter, as shown in FIG. 7. In more detail, the cartridge filter 170b includes a head 171 having an inlet 172 and an outlet 173, and a filtration portion 174 comprising a filter chamber 175 provided with a filter cartridge 179. Like the spin-down filter, the cartridge filter may be coupled to the system 100 in a similar manner and can be constructed from similar materials. Many different types of cartridges 179 can be used, for example, carbon wrapped, polypropylene string wound, polypropylene spun, polypropylene pleated, polytetrafluoroethylene (PTFE) pleated, pleated cellulose, resin bonded, stainless steel, ceramic, etc. It should be appreciated, of course, that alternative filter cartridges are possible. In a non-limiting example, the filter chamber can be screwed on and off of the head 171, thus allowing a user to easily access and replace soiled filter cartridges. In other examples, the filter chamber 175 may snap into position. Like the spin-down filter, an O-ring may be included in the connection. While spin-down filters and cartridge filters are shown and described in conjunction with the filtration system 100, alternative pre-filters are contemplated within the meaning of this disclosure.

The filtration system 100 additionally includes a water sampling system 180 having one or more water sample valves. The sample system 180 is configured to allow a user to sample the water supply in various locations along a path of the flow of water within the water treatment system. Testing the water in this manner provides assurance that harmful contaminants are removed. The water sample valves may be any NSF-certified or NSF-listed valve, such as a ball valve. In the figures, sample valves 181, 182, and 183 include a handle 185 and a sample port 186. Sample port may be smooth bore and can advantageously include a configuration of ridges, for example, to connect to a hose. The water sample valves are disposed in a fitting, such as a tee joint 184, which may be coupled in-line within the system 100. In a non-limiting example, the system 100 can include three (3) water sample valves; however, more than three are possible. In a typical construction, a first water sample valve 181 is provided coupled between the water supply POE 210 and the first tank of the dual tank system 150; a second water sample valve 182 is provided coupled between the first and second tanks 150a, 150b of the dual tank system; and a third water sample valve 183 is provided coupled in series following the second tank of the dual tank system. In another example, water sample valves can be provided in series both before and after the pre-filter system 170.

The water treatment system additionally includes a totalizing meter 190 provided to monitor and measure the cumulative flow volume and flow rate of water passing through the water treatment system. The totalizing meter 190 provides the means for a user to optimize scheduled maintenance and prevent system failure. According to one or more implementations, the totalizing meter may be provided coupled in series (in-line) within the system, for example, prior to a point of exit 240 of the system. It should be appreciated, of course, that other configurations are possible, and the individual components of the system described herein can be provided in a variety of orders. In the example, meter 190 comprises an inlet 191 and outlet 192, a measuring chamber 193 including a propeller or impeller (not shown), and a display 194 comprising a counter and a plurality of dials. The propeller is mechanically coupled to the components of the display. In more detail, water flowing through the chamber 193 causes the propeller to spin, which in turn can be read using the counter and dials as a flow rate or a cumulative flow volume passing through the system 100. In the example shown, totalizing water meter is constructed of nylon. Although, other materials are possible, including brass, stainless steel, and cast iron.

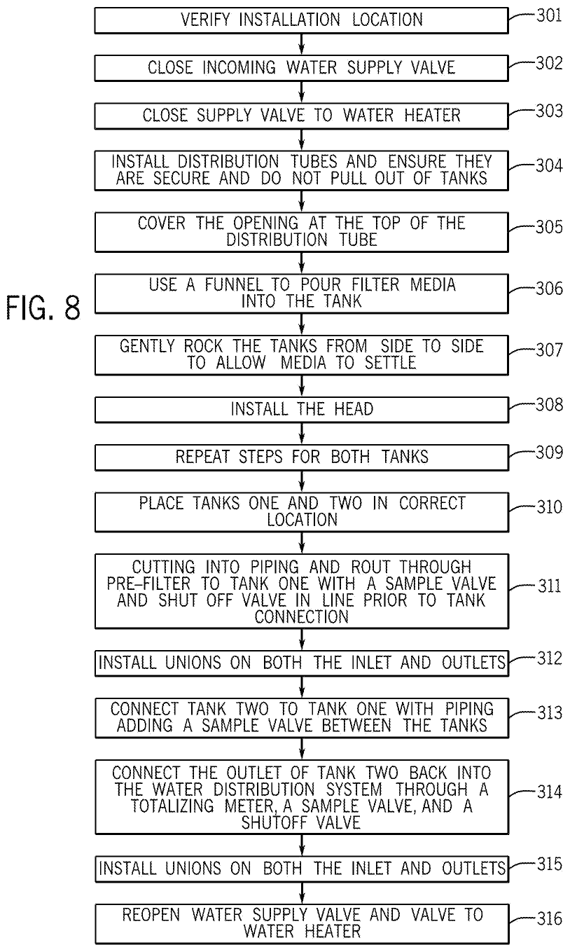

A method of installing an example water treatment system is described in FIG. 8. In a first step 301, the installation location must be verified. Areas subject to freezing or direct sunlight should be avoided. The water supply valve is closed in step 302 prior to assembling the components of the system. Similarly, in step 303 the water heater supply valve is closed to prevent damage to the heater. Next, each of the first and second filter tanks 150a, 150b are assembled and prepared for use with the system 100. Steps 304-309 are preferably performed outdoors or in a well-ventilated area. To begin, distribution tube 304 is installed and secured in each of tanks 150a, 150b. In steps 305 and 306, the opening 251 at the top of the distribution tube is covered before using a funnel to add the filter media 120. Gravel filter media 140 is filled prior to adding the activated carbon filter media 130. Care should be taken to ensure gravel filter media bed covers the distribution apparatus 270. Tanks may be gently rocked from side to side to allow the filter media to settle in step 307. In steps 308-310, the head is installed on each of tanks 150a, 150b and the tanks are moved into position. The components of the system are plumbed in steps 311-315. More specifically, the water supply piping is cut into to be routed through a pre-filter system 170, a shut-off valve 230, and a water sample valve 181. In step 312, unions 225 are installed on both the inlets 151 and outlets 152 of the first and second tanks. The first and second tanks are coupled including a water sample valve 182 provided between the tanks. In step 314, the outlet of the second tank is routed back into the water distribution system through a totalizing meter 190, a sample valve 183, and a shut-off valve 230. In step 315, unions 225 are installed at the water supply and water distribution system. Finally, in step 316 the water supply and water heater supply valves are re-opened.

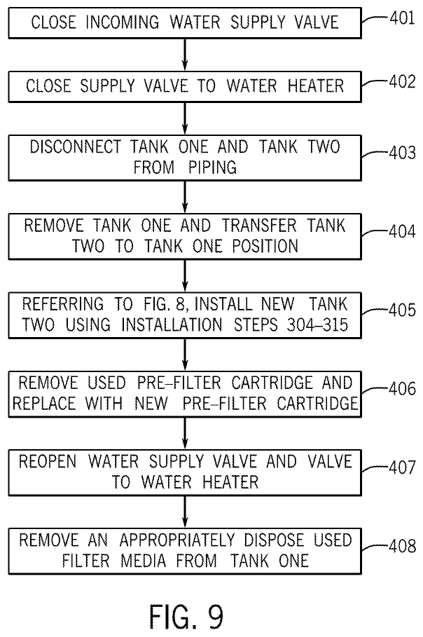

Moving to FIG. 9, a method of replacing an exhausted filter tank is shown. Similar to the installation steps, the incoming water supply and water heater supply valves are closed in steps 401 and 402. In step 403, the first and second tanks are disconnected. Next, the first tank is removed, and the second tank is transferred into the first tanks position. Referring to installation steps 4-15, the new second tank is installed in the second tank position. In step 406, the pre-filter system 170 can be either purged (e.g., for spin-down filters) or the filter cartridge may be replaced (e.g., for cartridge sediment filters). Following step 406, each of the water supply and water heater supply valves are re-opened in step 407. Exhausted filter media is removed from the first tank and appropriately disposed of in the final step 408, for example, by incineration.

Although implementation of the water treatment system 100 is particularly well suited for an aftermarket application, it should be understood that the system 100 may be provided as a part of original construction/plumbing. The filtration system 100 described herein may be manufactured and sold separately as an aftermarket product for application to an existing water supply or may be applied to original plumbing systems. In addition, it should be appreciated that the filtration system according to one or more constructions may be integral to the water supply point of entry, or their components, such as the original piping.

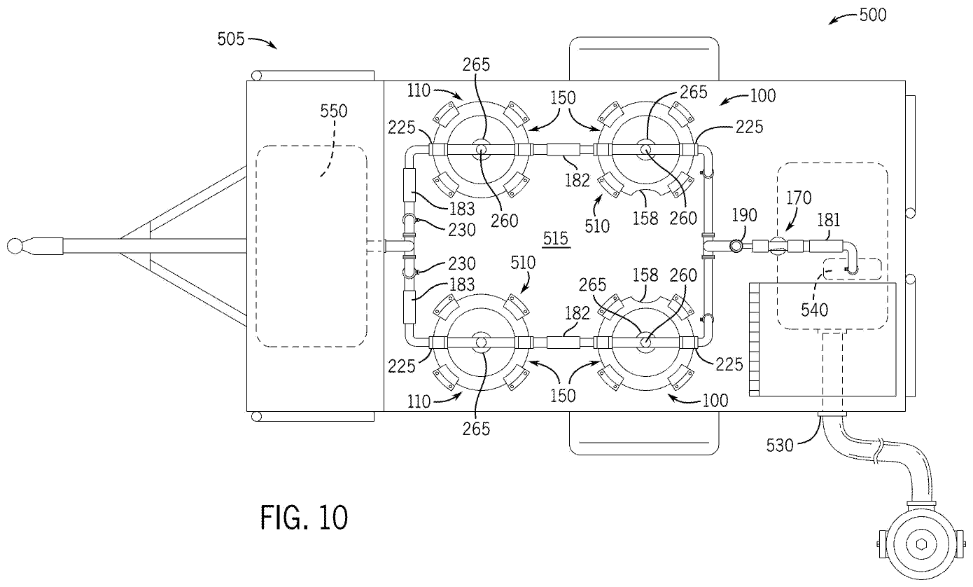

As mentioned above, the water treatment system 100 can be implemented in a wide variety of mobile or portable settings. For example, the components of the system described herein may be assembled and mounted in/on a vehicle or may be configured to be installed in a trailer, such as in the construction shown in FIG. 10. An example portable system 500 can include one or more dual tank systems 150 to facilitate a variety of filtration needs. In the figure, a first and second dual tank system are coupled to one another in a parallel or combined configuration and shown installed in a vehicle trailer 505. According to one or more constructions, the portable system 500 includes a structural support feature 510 to install and firmly secure and the portable system within a vehicle or trailer. An example support feature may comprise a platform 515 for mounting the system and a mechanism 520 to secure the system such as a frame having straps or tie downs. Other mechanisms for securing the system 500 are possible. An inlet of the system 530 may be modified to couple to or tap into a variety of water supplies, such as a municipal hydrant or a water well. In the example construction, the portable system 500 includes a hatch or door 540 in a floor of the vehicle trailer to facilitate seamless pumping from a water well. In such an example, the system can additionally include a variable speed pump (not shown) to feed water through the treatment system. Consistent with the implementations described above, the portable system 500 includes a pre-filter system 170, a water sample valve 180, and a control valve 230 plumbed in series which inlet water must pass through prior to entering either of the dual tank systems 150. In the example shown, a control valve 230 is installed to control the flow of water into either of the first and second dual tank systems 150, the valve may additionally be configured to allow water to pass through both systems simultaneously. Additional water sample valves 180 are provided coupled between each tank of the first and second dual tank systems, as well as in series following each of the dual tank systems. In similar fashion, a totalizing meter is provided coupled in series following each of the first and second dual tank systems. After passing through the components of the system 500, treated water is routed to an outlet 550 for distribution. While a select portable construction is shown and described, it should be appreciated, of course, that elements of the portable implementation may instead be used in a non-portable application and vice versa.

One or more of the disclosed embodiments, alone or in combination, may provide one or more technical effects including providing a means for a user to fully remove VOCs, PFAS, and other harmful contaminants and compounds from a water supply. The technical effects and technical problems in the specification are exemplary and are not limiting. It should be noted that the embodiments described in the specification may have other technical effects and can solve other technical problems.

As utilized herein, the terms “approximately,” “about,” “substantially,” “sufficient,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise characteristics provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom,” “left” and “right,” “front” and “back,” “in” and “out”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (e.g., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g. AB, AC, BC, or ABC).

It is also important to note that the construction and arrangement of the system, methods, and devices as shown in the various examples of embodiments is illustrative only, and not limiting. Although only a few embodiments have been described in detail in this disclosure, those skilled in the art who review this disclosure will readily appreciate that many various alternatives, modifications, variations, improvements and/or substantial equivalents, whether known or that are or may be presently foreseen, are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes, and omissions may be made in the design, operating conditions, and arrangement of the various examples of embodiments without departing from the spirit or scope of the present inventions. Therefore, the invention is intended to embrace all known or earlier developed alternatives, modifications, variations, improvements and/or substantial equivalents.

1. A water treatment apparatus comprising:
a pre-filter system;
an activated carbon filtration system including a filter media;
a water sampling system having a water sample valve;
a totalizing meter; and
a piping system configured to couple the pre-filter system, the activated carbon filtration system, the water sampling system, and the totalizing meter.

2. The water treatment apparatus of claim 1, further comprising a shut-off control valve.

3. The water treatment apparatus of claim 1, wherein the pre-filter system comprises a spin-down sediment filter.

4. The water treatment apparatus of claim 1, wherein the pre-filter system comprises a cartridge sediment filter.

5. The water treatment apparatus of claim 1, wherein the activated carbon filtration system comprises a dual tank system having a first filter tank and a second filter tank coupled in series, and wherein each of the first and second filter tanks, respectively, includes the filter media.

6. The water treatment apparatus of claim 5, wherein the filter media comprises a first filter media and a second filter media.

7. The water treatment apparatus of claim 6, wherein the first filter media comprises an activated carbon filter media and the second filter media comprises a gravel filter media.

8. The water treatment apparatus of claim 7, wherein the activated carbon filter media includes a coconut shell-based activated carbon filter media.

9. The water treatment apparatus of claim 5, wherein each of the first and second filter tanks, respectively, includes a distribution tube having a distribution apparatus coupled thereto.

10. The water treatment apparatus of claim 9, wherein the distribution apparatus comprises a distribution basket.

11. The water treatment apparatus of claim 9, wherein the distribution apparatus comprises a hub and lateral system.

12. The water treatment apparatus of claim 9, wherein the distribution apparatus comprises an aperture to evenly distribute water within each of the first and second filter tanks.

13. The water treatment apparatus of claim 1, wherein the piping system is configured to couple the pre-filter system in series with the activated carbon filtration system, and wherein the piping system is configured to couple the activated carbon filtration system in series with the totalizing meter.

14. The water treatment apparatus of claim 5, wherein a first water sample valve is provided coupled in series between the pre-filter system and the activated carbon filtration system, a second water sample valve is provided coupled in series between the first filter tank and the second filter tank of the activated carbon filtration system, and a third water sample valve is provided coupled in series between the activated carbon filtration system and the totalizing meter.

15. The water treatment apparatus of claim 1, wherein a flow rate of water in the activated carbon filtration system is configured to maintain a specified contact time with the filter media.

16. The water treatment apparatus of claim 15, wherein the specified contact time is at least seven minutes.

17. The water treatment apparatus of claim 15, wherein the specified contact time is at least ten minutes.

18. A method of utilizing a water treatment apparatus for removing volatile organic compounds and polyfluoroalkyl substances from a water supply, the water treatment apparatus comprising an activated carbon filtration system, the activated carbon filtration system including an activated carbon filter media, the method comprising:
passing water through the water treatment apparatus;
configuring a flow rate of water passing through the activated carbon filtration system; and
maintaining the water within the activated carbon filtration system such that the water remains in contact with the activated carbon filter media for a specified contact time.

19. The method of claim 18, wherein the specified contact time is at least seven minutes.

20. The method of claim 18, wherein the specified contact time is at least ten minutes.
